(19) United States
(12) Patent Application Publication
(10) Pub. No.: US 2022/0341494 A1
(43) Pub. Date: Oct. 27, 2022

(54) GASKET PLATE

(71) Applicant: The Oilgear Company, Traverse City, MI (US)

(72) Inventors: DENNY WING-CHI CHEUNG, Kingsley, MI (US); CHRISTOPHER M. GRIGSBY, Grawn, MI (US); Samuel Holmes, Williamsburg, MI (US)

(21) Appl. No.: 17/729,889

(22) Filed: Apr. 26, 2022

Related U.S. Application Data
(60) Provisional application No. 63/179,871, filed on Apr. 26, 2021.

(51) Int. Cl. F16J 15/08

(52) U.S. Cl. CPC F16J 15/0818

(57) ABSTRACT

A gasket plate having a rigid orientation plate retaining at least one seal in a predetermined location in the orientation plate, and a rigid insert placed inside the seal such that the seal interposes the insert and the orientation plate.

### CROSS-REFERENCE TO RELATED CASES

This application claims the benefit of U.S. provisional patent application Ser. No. 63/179,871, filed on Apr. 26, 2021, and incorporates such provisional application by reference into this disclosure as if fully set out at this point.

### FIELD OF THE INVENTION

This disclosure relates to hydraulic components in general and, more particularly, to gasket plates for use in hydraulic circuits and machines.

### BACKGROUND OF THE INVENTION

Interfaces between certain hydraulic circuit components may rely on gasket plates having a set of opposed grooves defined on opposite sides of the plate where a hydraulic pathway is joined. Gaskets may be placed in the opposed grooves to seal the adjacent components. A gasket plate may contain several such opposed sets of grooves so as to seal multiple hydraulic circuits or pathways. If a single gasket becomes damaged it may be difficult or impossible to repair the gasket or the associated portion of the plate. Thus, a relatively complex and costly component may have to be scrapped even though all but a portion of the gasket plate is still intact.

What is needed is a system and method for addressing the above and related issues.

### SUMMARY OF THE INVENTION

The invention of the present disclosure, in one aspect thereof, comprises a gasket plate having a rigid orientation plate retaining at least one seal in a predetermined location in the orientation plate, and a rigid insert placed inside the seal such that the seal interposes the insert and the orientation plate and defines a passageway through the orientation plate.

In some embodiments, the seal defines an outer tongue fitting into a groove defined in the insert. The seal may comprise rubber and may be vulcanized to the insert. The seal may define an inner tongue fitting into a groove defined by the orientation plate.

The invention of the present disclosure, in another aspect thereof, comprises a gasket plate having a planar orientation plate having a thickness and defining a passage through the thickness, the passage defining a passage wall, an elastomeric seal abutting the passage wall, and a rigid, annular insert contacting the elastomeric seal and retaining the seal against the passage.

The elastomeric seal may comprise a rubber and be vulcanized to the insert. The insert may stretch the elastomeric seal and press it into the passage wall. In some embodiments, the passage wall defines a groove that receives at least part of the elastomeric seal. The elastomeric seal may provide a tongue fitting into the passage wall. In some embodiments, the rigid insert defines a groove that receives part of the elastomeric seal. The elastomeric seal may define a tongue fitting into the groove of the elastomeric seal.

The invention of the present disclosure, on another aspect thereof, comprises a gasket plate having an orientation plate having a thickness and a passage defined therethrough, an elastomeric seal in the passage, a rigid, annular insert contacting the elastomeric seal and preventing collapse of the elastomeric seal away from a passage wall, and means for preventing slippage of the elastomeric seal against the passage wall.

In some embodiments, the means for preventing slippage of the elastomeric seal against the passage wall comprises a textured surface on the passage wall. In other embodiments, the means for preventing slippage of the elastomeric seal against the passage wall comprises a tongue and groove arrangement between the elastomeric seal and the passage wall.

The gasket plate may further comprising means for securing the elastomeric seal to the insert. The means for securing the elastomeric seal to the insert may comprise vulcanizing the elastomeric insert to the insert. In other embodiments, the means for securing the elastomeric seal to the insert comprises a tongue and groove arrangement between the elastomeric seal and the insert.

In some embodiments, the elastomeric seal is annular. It may define inner and outer tongues fitting into a groove defined on the insert and a groove defined in the passage wall, respectively. The elastomeric seal may define upper and lower tongues on upper and lower surfaces thereof, respectively, facing away from a plane of the orientation plate.

### BRIEF DESCRIPTION OF THE DRAWINGS

FIG. 1 is a top view of one embodiment of a gasket plate according to aspects of the present disclosure.

FIG. 2 is a side cutaway view of the gasket plate of FIG. 1 taken along the line B-B.

FIG. 3 is a top view of another embodiment of a gasket plate according to aspects of the present disclosure.

FIG. 4 is a side cutaway view of a portion of the gasket plate of FIG. 3 taken along the line A-A.

FIG. 5 is a top view of a seal insert for use with the gasket plate of FIG. 3.

FIG. 6 is a perspective view of another gasket plate according to aspects of the present disclosure.

FIG. 7 is a perspective view of a gasket and insert of the gasket plate of FIG. 6.

FIG. 8A is a cutaway exploded view of a portion of the gasket plate of FIG. 6.

FIG. 8B is a close-up view of a portion of FIG. 8 showing interface detail.

### DETAILED DESCRIPTION OF THE PREFERRED EMBODIMENTS

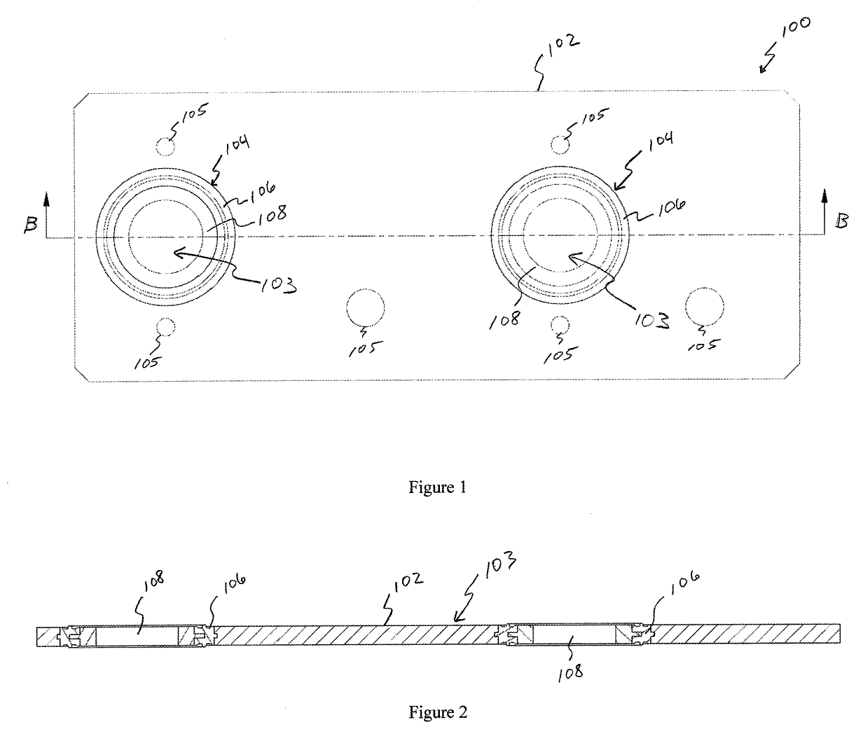

FIG. 1 is a top view of one embodiment of a gasket plate 100 according to aspects of the present disclosure. The gasket plate 100 is shown with two gaskets 104 but it should be understood that a gasket plate may provide many more gaskets, and these may differ in size and placement from those shown for illustration. The gasket plate 100 may comprise a rigid, possibly planar, orientation plate 102 that ensures each gasket 104 lines up at the appropriate location where the gasket plate 100 is installed. Mounting holes 105, the shape of plate 104, and other mechanisms may be utilized to ensure proper mounting and placement.

The gaskets 104 may comprise a seal 106 and an inner insert 108 defining a passage 103 (for hydraulic oil or other fluids) through the gaskets 104 and the plate 102. The orientation plate 102 and insert 108 may comprise metals, alloys, polymers, or other materials are known in the art. The insert 108 may be rigid, annular component. The seal 106 may be a rubber seal or comprise other materials as are known in the art to be serviceable within the associated hydraulic circuit. These include, without limitation hydrogenated acrylonitrile butadiene rubber (HNBR), Viton®, ethylene propylene diene monomer (EPDM), styrene-butadiene rubber (SBR), nitrile rubber, silicon rubber, and other materials.

FIG. 2 is a side cutaway view of the gasket plate of FIG. 1 taken along the line B-B. Here it can be seen that the seal 106 may comprise a tongue fitting into a groove defined laterally into the plane of the plate 102 where the seal is located. In other embodiments, the plate 102 may define the tongue and the seal 106 define the groove. Additionally, only a single tongue and groove is shown but other embodiments may provide multiple tongue-groove pairs.

The insert 108 may be solid or rigid and serve to anchor the seal 106 (which may be somewhat flexible or elastomeric) firmly into the plate 102. It may also serve to prevent the seal 106 from being drawn into the hydraulic circuit where pressures are such that the seal 106 would tend to be pulled inward or collapse. The insert 108 may define a tongue fitting into a groove in the seal 106. In other embodiments, the tongue and groove may be reversed, and/or multiple tongue-groove pairs may be provided. In an additional particular embodiment, the seal 106 defines opposite grooves that receive a tongue from both the plate 102 and the insert 108, respectively, but a reverse configuration is also contemplated.

As discussed further below, other mechanisms for securing the relationship and position between the plate 102, seal 106, and insert 108 are contemplated.

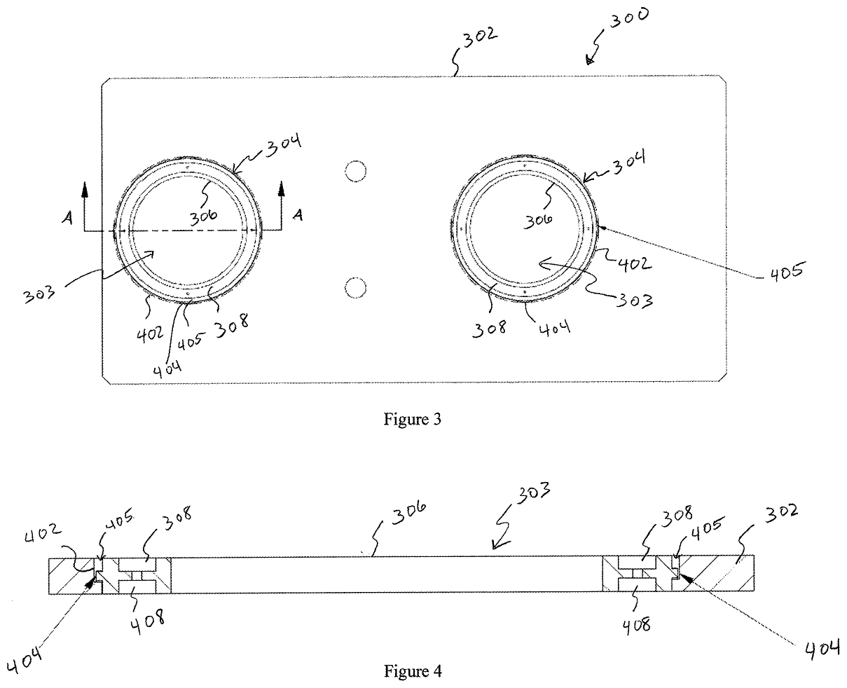

Referring now to FIG. 3, a top view of another embodiment of a gasket plate 300 according to aspects of the present disclosure is shown. Again, two gaskets 304 are shown in an orientation plate 302 but more or fewer, possibly of different sizes and placements, are contemplated. Referring also FIG. 4, a side cutaway view of a portion of the gasket plate 300 of FIG. 3 taken along the line A-A is shown.

In this embodiment, an insert 306, possibly comprising a metal, alloy, polymer, or other rigid material provides a pair of opposed grooves 308, 408. One of both of these receives a seal (not shown) serving to complete the sealing function of the gasket 304. However, each of the gaskets 304 is separately removeable and replaceable in case of damage or other eventuality. As before, the gaskets 304 and their components define openings 303 through the plane of the orientation plate 302.

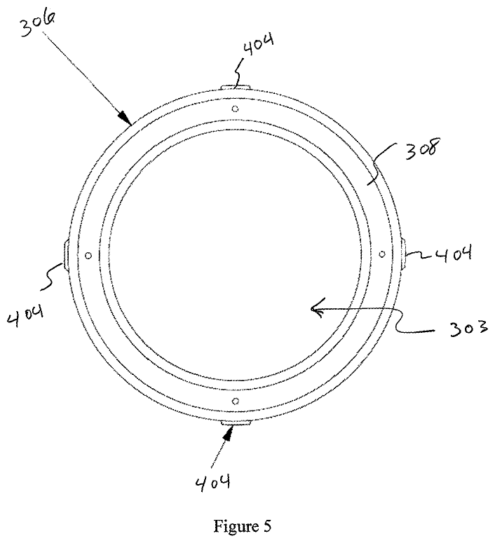

Referring now also to FIG. 5, a top view of a seal insert 306 for use with the gasket plate 300 of FIG. 3 is shown. The plate 302 may comprise a groove 402 defined in the plane of the plate 302. Tabs 404 defined on the insert 306 may fit into the groove 402 to retain the insert 306. Cutouts 405 into the plane of the plate 302 may be defined to correspond to placement of the tabs 404 to provide access to fit the tabs 404 into the groove 402. The insert 306 may be inserted into the plate by alignment of the tabs 404 with the cutouts 405 and then rotated (e.g., about 45 degrees where 4 equally angularly spaced cutouts 405 and tabs 404 are provided) to prevent loss of the insert 306 from the plate 302. The fit between the groove 402 and tabs 404 may provide sufficient friction to prevent further rotation of the insert 306 until the plate 300 is installed, at which point pressure of the adjacent components would normally prevent further rotation. In other embodiments an adhesive may be used in the groove 402. As with other embodiments, the location of the groove and tabs could be reversed such that tabs on the plate 302 fitted into a groove on the insert 306 that is then rotated to a secure position.

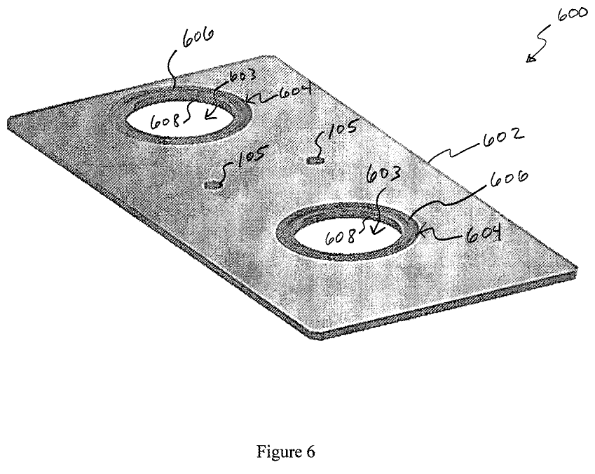

Referring now to FIG. 6 is a perspective view of another gasket plate 600 according to aspects of the present disclosure is shown. The gasket plate 600 is similar to gasket plate 100 except as otherwise described. The gasket plate 600 may comprise an orientation plate 602 that is generally planar but have a thickness associated with it. The shape and mounting holes 105 of orientation plate 602 may serve to properly locate and orient the plate 602 when installed in a specific application but the shape and mounting holes 105 may vary from the example shown.

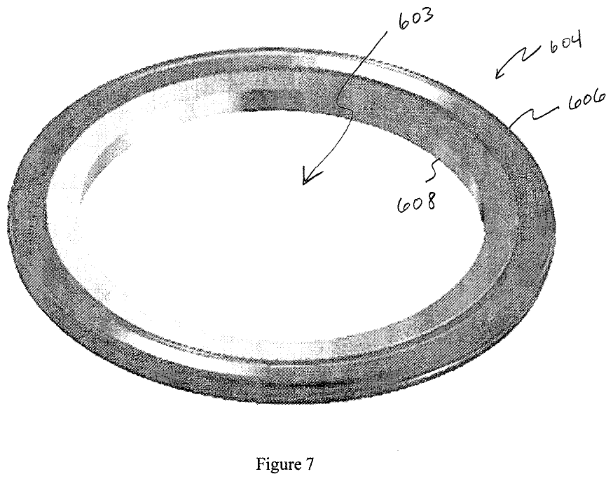

The gasket plate 600 may comprise one or more gaskets 604 in the orientation plate 602. These may comprise seals 606 fitted into openings 603 through the plane of the orientation plate and having inserts 604 inside the seals 604. Seals 606 and inserts 604 may comprise similar materials to seals 106 and inserts 104, respectively, of gasket plate 100. FIG. 7 is a perspective view of gasket seal 606 and insert 608 apart from orientation plate 602.

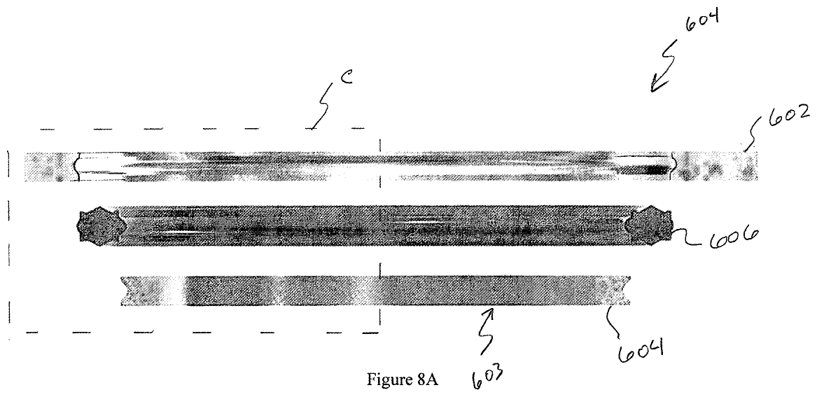

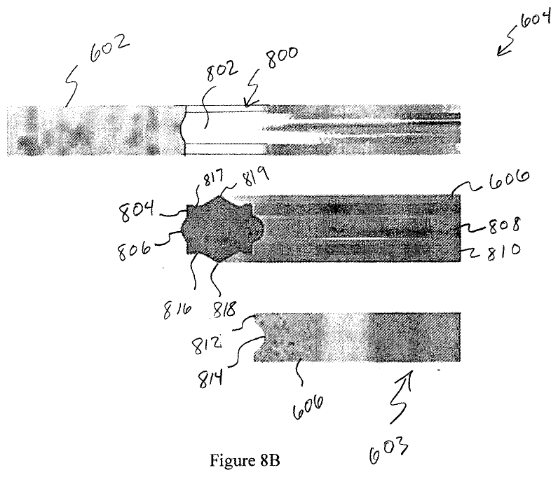

With reference now also to FIG. 8A, which is a a cutaway exploded view of a portion of the gasket plate of FIG. 6, and to FIG. 8B which is a closeup view as denoted in box C of FIG. 8A, various mating and securement features between various components can be seen. The orientation plate 602 can be seen to comprise a shallow, generally cylindrical passage 800 through the plane thereof. This provides a retaining location for the various gasket components including seal 606 and insert 604. The seal 606 may be somewhat compressed between the insert 604 and the passage 800 of the orientation plate 602.

In some embodiments, the seal 606 may be placed onto the insert 604 in an uncured state and then vulcanized in place to adhere to the insert 604. The seal 606 may be molded in place and bonded to the insert. In other embodiments, the seal 606 may be glued to the insert 604. In further embodiments the seal 606 may be stretch fitted onto the insert 604 and/or retained in the orientation plate 602 by compression (e.g., being pressed into or against the passage 800 by the insert 604).

The seal 606 and insert 604 can be removed or placed into the orientation plate 602 as an integrated piece. In some embodiments, the passage 800 is not wholly cylindrical all the way through the orientation plate 602. A shape or texture may be provided on the passage 800 that cooperates with a shape of an outer portion of the seal 606 such that there is a mechanical retention, friction, or interference fit to hold the seal 606 in place for movement, transportation, or orientation by the orientation plate 602.

As illustrated, a tongue and groove arrangement is provided between the orientation plate 602 and the seal 606. A groove 802 is cast, machined, or otherwise provided in the passage 800 (laterally into the plane of the plate 602) to receive a protrusion or tongue 806 on the outer rim of the seal 606. The tongue 806 may be cast, molded or machined. In some embodiments, the tongue 806 or protrusion may comprise substantially all of an outer rim of the seal 606. However, the seal 606 may comprise a flat wall portion 804 on one of both sides of the tongue 806, and these may abut a corresponding flat portion of the passage 800.

An inner rim of the seal 606 may also have mechanical retention features that mesh with the insert 604. A tongue and groove arrangement is shown with a tongue 808 on the seal 606 to fit into a groove 814 on the insert 604. In some embodiments, the insert 604 provides flat portions 812 on either side of the groove 814 that rest against flat portions 810 on either side of the tongue 606.

It should be understood that the seal 606, being elastomeric, may have a different shape if/when stretched from that when it is not stretched. The seal 606 may be annular as produced or molded, or may have anot4her shape that becomes annular when placed with its adjacent components (e.g., wall 800 and/or insert 606). The seal 606 may be considered as having inner and outer rings (with tongues 806, 808, thereon) but may also have lower and upper surfaces 816, 817, respectively that provide sealing contact against the remaining of the hydraulic circuit into which the seal 606 is inserted. Lower and upper tongues 818, 819 may be provided on the lower and upper surfaces 816, 817, respectively for sealing into adjacent components (not shown).

It should be understated that in any tongue and groove arrangement shown, the tongues and grooves may be reversed. In some cases, there are multiple tongues and grooves at some or all locations. Additionally, other contours that would tend to increase sealing effects can also be used. These include, but are not limited to complementary s-curves, zig-zag profiles, textured surfaces, and others.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A gasket plate comprising:
a rigid orientation plate retaining at least one seal in a predetermined location in the orientation plate; and
a rigid insert placed inside the seal such that the seal interposes the insert and the orientation plate and defines a passageway through the orientation plate.

2. The gasket plate of claim 2, wherein the seal defines an outer tongue fitting into a groove defined in the insert.

3. The gasket plate of claim 2, wherein the seal comprises rubber and is vulcanized to the insert.

4. The gasket plate of claim 2, wherein the seal defines an inner tongue fitting into a groove defined by the orientation plate.

5. A gasket plate comprising:
a planar orientation plate having a thickness and defining a passage through the thickness, the passage defining a passage wall;
an elastomeric seal abutting the passage wall; and
a rigid, annular insert contacting the elastomeric seal and retaining the seal against the passage.

6. The gasket plate of claim 5, wherein the elastomeric seal comprises a rubber and is vulcanized to the insert.

7. The gasket plate of claim 5, wherein the insert stretches the elastomeric seal and presses it into the passage wall.

8. The gasket plate of claim 5, wherein the passage wall defines a groove that receives at least part of the elastomeric seal.

9. The gasket plate of claim 8, wherein the elastomeric seal provides a tongue fitting into the passage wall.

10. The gasket plate of claim 5, wherein the rigid insert defines a groove that receives part of the elastomeric seal.

11. The gasket plate of claim 10, wherein the elastomeric seal defines a tongue fitting into the groove of the elastomeric seal.

12. A gasket plate comprising:
an orientation plate having a thickness and a passage defined therethrough;
an elastomeric seal in the passage;
a rigid, annular insert contacting the elastomeric seal and preventing collapse of the elastomeric seal away from a passage wall; and
means for preventing slippage of the elastomeric seal against the passage wall.

13. The gasket plate of claim 12, wherein the means for preventing slippage of the elastomeric seal against the passage wall comprises a textured surface on the passage wall.

14. The gasket plate of claim 12, wherein the means for preventing slippage of the elastomeric seal against the passage wall comprises a tongue and groove arrangement between the elastomeric seal and the passage wall.

15. The gasket plate of claim 12, further comprising means for securing the elastomeric seal to the insert.

16. The gasket plate of claim 15, wherein the means for securing the elastomeric seal to the insert comprises vulcanizing the elastomeric insert to the insert.

17. The gasket plate of claim 15, wherein means for securing the elastomeric seal to the insert comprises a tongue and groove arrangement between the elastomeric seal and the insert.

18. The gasket plate of claim 12, wherein the elastomeric seal is annular.

19. The gasket plate of claim 18, wherein the elastomeric seal defines inner and outer tongues fitting into a groove defined on the insert and a groove defined in the passage wall, respectively.

20. The gasket plate of claim 19, wherein the elastomeric seal defines upper and lower tongues on upper and lower surfaces thereof, respectively, facing away from a plane of the orientation plate.
